(19) United States
(12) Patent Application Publication
(10) Pub. No.: US 2012/0181909 A1
(43) Pub. Date: Jul. 19, 2012

(54) SYNCHRONIZATION DEVICE FOR SYNCHRONIZING TWO ACTUATING DRIVES FOR MOVING A MOVABLE FURNITURE PART

(76) Inventors: Olaf ISELE, Lustenau (AT); Harald Sutterluetti, Fussach (AT)

(21) Appl. No.: 13/429,571

(22) Filed: Mar. 26, 2012

Related U.S. Application Data
(63) Continuation of application No. PCT/AT2010/000379, filed on Oct. 11, 2010.

(30) Foreign Application Priority Data
Oct. 23, 2009 (AT) A 1673/2009

(51) Int. Cl. E05D 15/46; E05F 1/12

(52) U.S. Cl. 312/298

(57) ABSTRACT

The invention relates to a synchronization device for moving a first actuating device in synchronization with at least one second actuating device, wherein the first actuating device and the second actuating device are provided on a piece of furniture in the installed state in order to move a movable furniture part. The device includes a synchronization rod for transferring a synchronous motion of the at least two actuating devices, at least one fastening device, by which the synchronization rod can be detachably connected to at least one of the two actuating devices, wherein at least one detachable locking device is provided, which prevents the synchronization rod from being connected to the at least one fastening device in the locked state of the locking device, wherein the locking device is in the locking state without prior actuation by a user.

This application is a Continuation of U.S. application Ser. No. PCT/AT2010/000379, filed Oct. 11, 2010, the entire disclosure of which is incorporated herein by reference.

The present invention relates to a synchronization device for synchronous movement of a first actuating device with at least one second actuating device, wherein the first and second actuating devices in the mounted condition are provided on an article of furniture for moving a movable furniture part, including:
a synchronization rod for transmitting a synchronous movement of the at least two actuating devices, and
at least one fixing device by way of which the synchronization rod can be releasably connected to at least one of the two actuating devices.

The invention further concerns an article of furniture having at least one synchronization device of the kind to be described.

WO 2006/113953 A1 to the present applicant describes a synchronization device of the general kind set forth, wherein the movement of two actuating devices can be synchronized by a synchronization rod. In that way it is possible to implement a synchronous movement of the two actuating devices for driving a movable furniture part, in particular an upwardly movable flap. The two actuating devices are pre-assembled in a first mounting step to opposite side walls of the furniture carcass, whereupon in a subsequent mounting step the synchronization rod can be connected to a rotatable part of the respective actuating device by way of a fixing device. That connection between the synchronization rod and the rotatable part of the respective actuating device can be made by a latching connection or a screw connection. When using a screw connection it has frequently been found in practice that, due to lack of attention, the screw was not tightened at all from the outset by the mounting personnel. The loose screw means that an unwanted play remains between the synchronization rod and the rotatable part of the actuating device, which in most cases also results in an unharmonic movement of the two actuating devices relative to each other.

It is therefore an object of the present invention to propose a synchronization device of the general kind set forth in the opening part of this specification, having an improved fixing device.

In an advantageous configuration according to the invention that is achieved in that there is provided at least one releasable locking device which prevents the synchronization rod from being connected to the at least one fixing device in a locking condition of the locking device, wherein the locking device is in the locking condition without prior actuation by a user.

In other words there is proposed a releasable locking device having a locking condition and a release condition. When the locking device is in the locking condition, mounting of the synchronization rod to the respective actuating device is just not possible at all. It is only after the locking device has been moved into the release condition, triggered by intentional displacement by a user, that the synchronization device can be properly mounted to the respective actuating device.

The locking device can have for example a handle element which is adapted for hand actuation and which is manually movable against the force of a spring device upon mounting of the synchronization rod by a user into a position in which the locking device is in the release condition and thus mounting of the synchronization rod is possible. If in contrast the handle element is not actuated by a user, then the locking device is in the locking position and fitment of the synchronization rod is not possible.

In that respect, the synchronization rod can be mounted to the rotatable or pivotable part of the actuating device by way of a fixing device which can be tightened. Substantially play-free arresting of the synchronization rod relative to the actuating drive makes it possible to implement synchronous actuating movement of the two actuating devices relative to each other.

In a preferred embodiment it can be provided that parts of the locking device also form parts of the fixing device, by which the synchronization rod can be secured relative to at least one the two actuating devices. In other words, existing parts of the locking device are also used at the same time as parts of the fixing device, by which the synchronization rod can be arrested to at least one actuating device. It is however also possible to involve locking devices which are separated from the actual fixing device.

The locking device can be moved manually without the use of a tool into a release condition or alternatively it can also have a receiving device for a tool, in particular a screwdriver, in which case the release condition can be brought about by suitable actuation of the tool.

The fixing device can have a handle element to be actuated by a person and at least one arresting element which can be released and arrested by the handle element so that, after positioning has been effected, the synchronization rod can be secured relative to at least one of the two actuating devices. In that respect it may be desirable if the arresting element can be loaded by a spring device in the direction of the arresting position or is continuously loaded by a spring device in the direction of the arresting position. In a structurally simple solution the at least one arresting element and the spring device can simultaneously also form parts of the locking device. In a first mounting step the pre-stressed arresting element serves as the locking device which firstly has to be deliberately moved by a user into the release condition against the spring force. It is only in that release condition that an end of the synchronization rod can be connected to a corresponding part of the actuating device, in which case automatic clamping and/or latching of the synchronization rod can be effected by the spring-loaded arresting element.

The handle element to be actuated manually can be in the form of a slider by which the arresting element is movable at least into the release position. In the mounting procedure therefore the slider is urged against the force of the spring device loading the arresting element, after positioning of the synchronization rod relative to the corresponding part of the actuating device has been effected, the manual force is removed from the slider, followed then by automatic clamping or latching of the arresting element to the corresponding part of the actuating device.

Alternatively the handle element can also have a pivotably mounted lever by which the arresting element can be clampingly fixed relative to at least one of the two actuating devices. In a preferred embodiment it can be provided that the pivotably mounted lever is also part of the locking device. In this connection it can also be provided that the fixing device has a cover means, wherein the cover means can be positioned over the other parts of the fixing device only when the synchronization rod is appropriately connected to at least one of the two actuating drives. The cover means thus forms a part of the fixing device, wherein the cover means can be mounted movably—in particular slidably—relative to the synchronization rod, preferably in such a way that it the cover means is captively secured to the synchronization rod.

The article of furniture according to the invention is characterized by at least one synchronization device of the described kind. In that case the two actuating devices can be mounted to opposite side walls of a furniture carcass, in which case a movement of the two actuating devices can be synchronized by way of the synchronization rod.

The article of furniture according to the invention is characterized by at least one synchronization device of the kind described.

Further details and advantages of the present invention are described with reference to the specific description hereinafter. In the drawing:

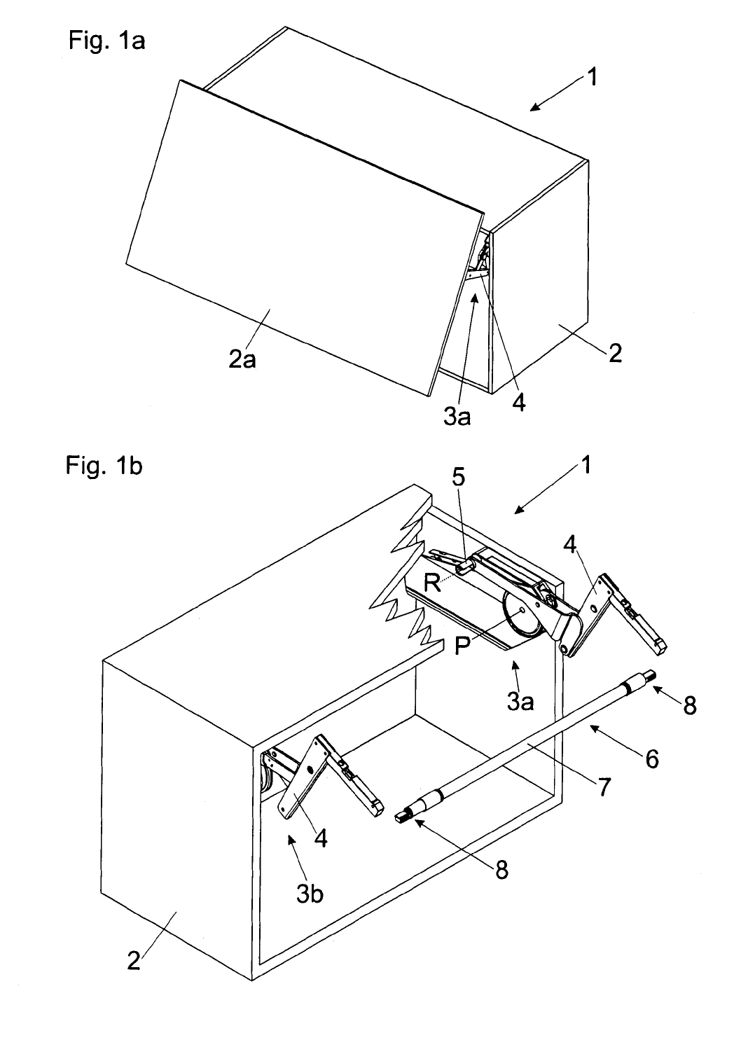

FIGS. 1a, 1b show a perspective view of an article of furniture with an upwardly movable flap and a partly broken-away view of the article of furniture with the flap removed,

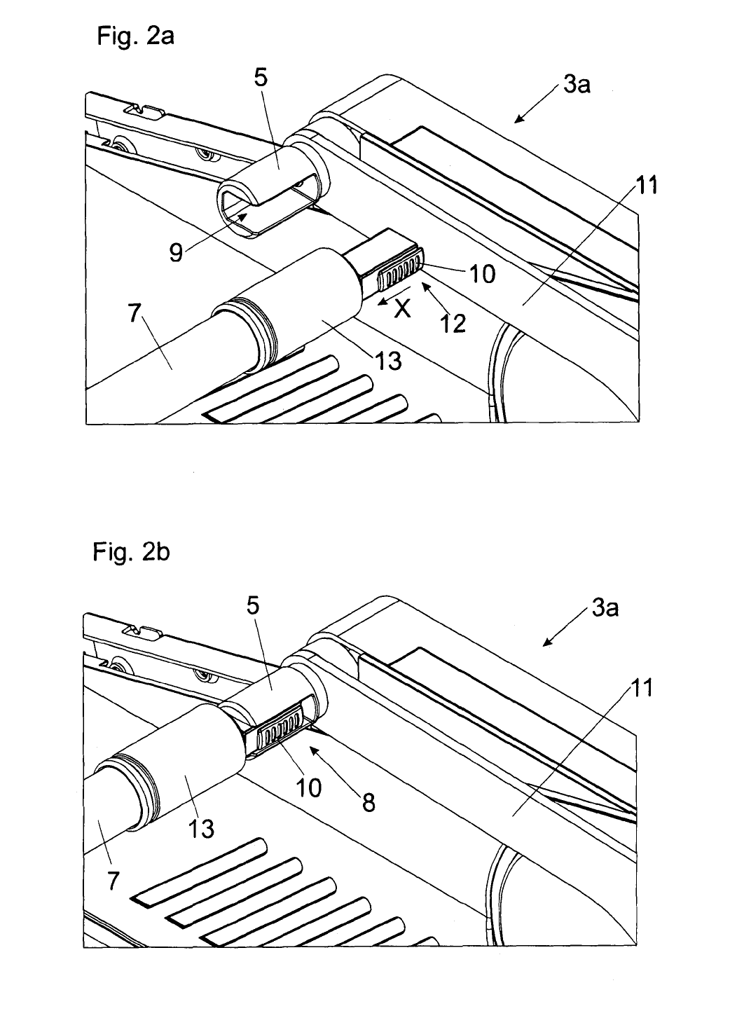

FIGS. 2a, 2b show the synchronization rod provided for synchronization of the two actuating devices with a locking device in the locking condition and a view of the synchronization rod mounted to the actuating drive,

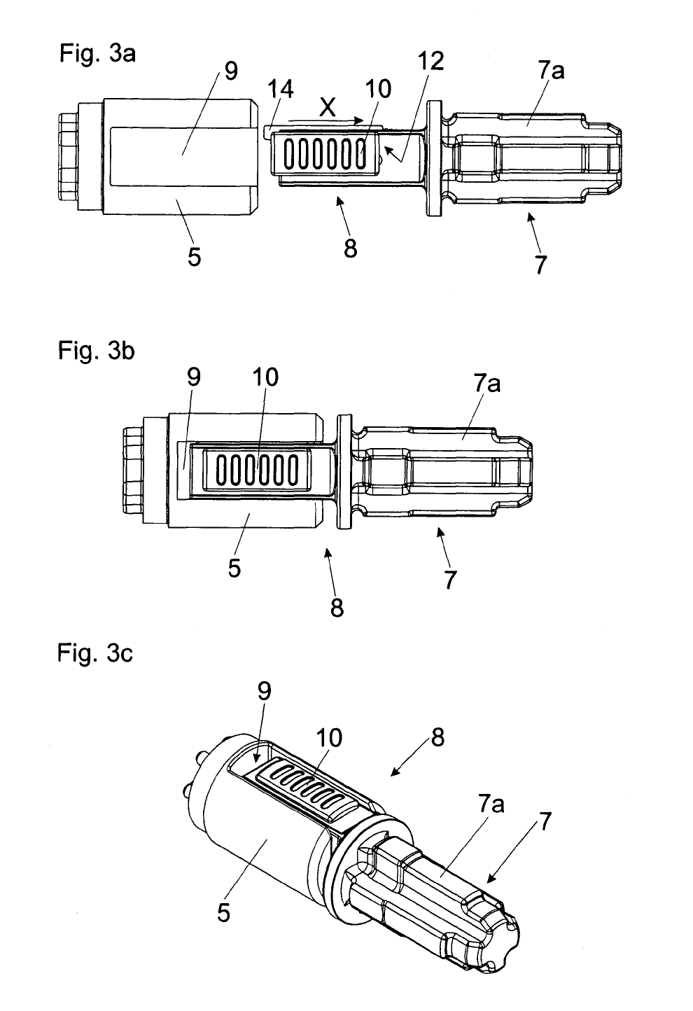

FIGS. 3a-3c show the locking device in the locking condition, a view in the mounted condition and a perspective view of the fixing device,

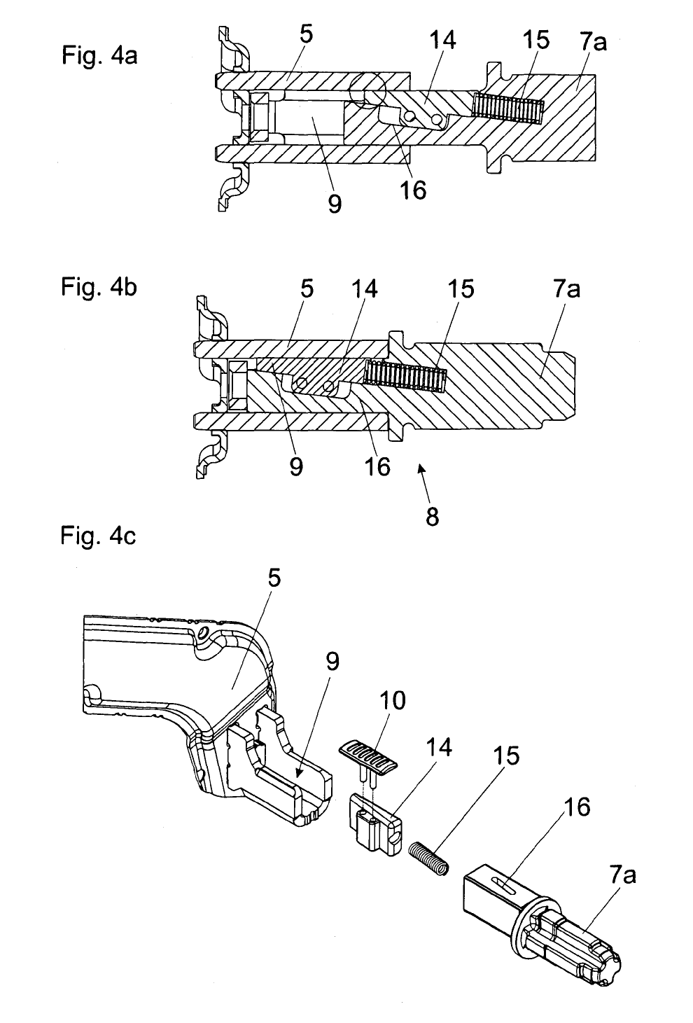

FIGS. 4a-4c show a view of the locking device in the release condition, in the mounted condition and an exploded view of the parts used, and

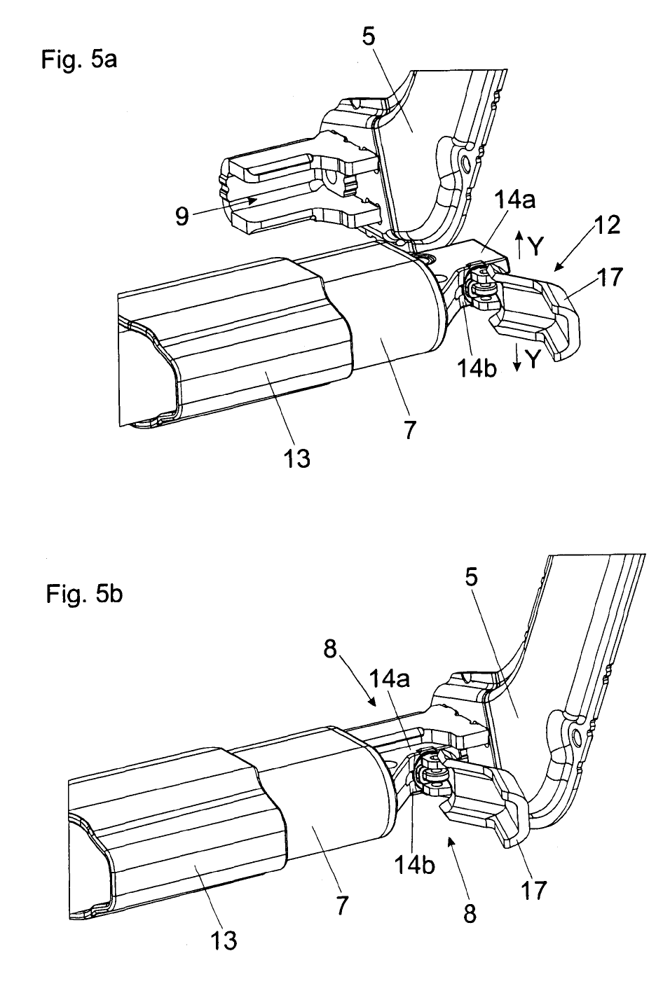

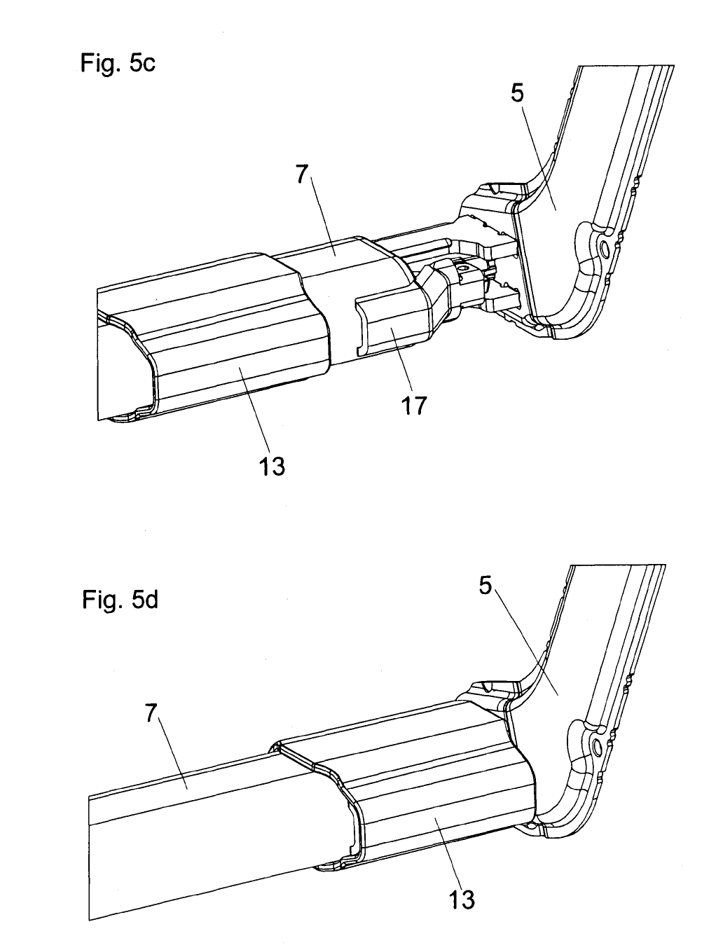

FIGS. 5a-5d show time sequences in mounting the synchronization rod to the rotatable part of the actuating drive, wherein the locking device is shown in a further embodiment.

FIG. 1 a shows a perspective view of an article of furniture 1 having a furniture carcass 2 and a flap 2a which is movable upwardly relative thereto. It is possible to see an actuating device 3a having at least one pivotably mounted actuating arm 4, the actuating device 3a being provided to move the flap 2a. FIG. 1b shows a perspective and partly broken-away view of the article of furniture 1 with the flap 2a removed, also showing the oppositely disposed actuating device 3b. The two actuating devices 3a, 3b can basically be identical and each have a drive device (not shown in greater detail here) in the form of a spring device and/or an electric motor, wherein the actuating arm 4 can be urged in the opening direction about the axis of rotation P by the drive device. The two actuating devices 3a and 3b each have a respective rotatable part 5 which is also rotated upon a movement of the flap 2a over a limited rotary angle range about the axis of rotation R. To synchronize a movement of the two actuating devices 3a and 3b there is a synchronization device 6 having an elongate synchronization rod 7 which can be releasably connected by way of a fixing device 8 to the rotatable part 5 of the respective actuating device 3a, 3b; it can preferably be fitted without a tool and/or can preferably be dismantled without a tool. When the synchronization rod 7 is properly connected to the rotatable part 5 of the respective actuating device 3a, 3b the desired synchronisation of the two actuating devices 3a and 3b relative to each other can be brought about.

FIG. 2a shows an enlarged view of the rotatable part 5 of the actuating device 3a shown in FIG. 1b. The rotatable part 5 is connected in a torque-proof manner to an intermediate lever 11 of the actuating device 3a so that upon a movement of the furniture flap 2a the intermediate lever 11 also rotates together with the rotatable part 5 over a limited rotary angle range about the axis of rotation R shown in FIG. 1b. The rotatable part 5 has a guide 9 for receiving and fixing the synchronization rod 7. The guide 9 is open forwardly so that the synchronization rod 7 can be connected to the rotatable part 5 even when the actuating device 3a with the rotatable part 5 was already pre-assembled to the furniture carcass 2.

In the illustrated embodiment in FIG. 2a the synchronization rod 7 has a locking device 12 which prevents the synchronization rod 7 from being connected in the locked condition of the locking device 12. In FIG. 2a the locking device 12 is in the locking condition, that is to say the synchronization rod 7 cannot be connected to the rotatable part 5 of the actuating device 3a without prior actuation of the handle element 10 because introduction of the synchronization rod 7 into the guide 9 of the rotatable part 5 is not possible when the locking device 12 is in the locking condition. It is only when the handle element 10 which in the illustrated embodiment is in the form of a linearly slidable slider is moved manually in the direction X in the mounting procedure that the locking device 12 is put into the release condition. Now with the handle element 10 pressed the synchronization rod 7 can be introduced into the guide 9 of the rotatable part 5 whereupon automatic and correct locking to the rotatable part 5 of the actuating device 3a is effected by releasing the handle element 10. The mounted condition of the synchronization rod 7 is shown in FIG. 2b. The synchronization rod 7 is therefore now fixedly connected to the rotatable part 5 of the actuating device 3a. That connection can be made by way of a force-locking and/or by way of an at least partly positively locking fixing device 8. A snap connection can be particularly desirably used in that respect. Mounted on the synchronization rod 7 is a preferably sleeve-shaped cover means 13 which after the synchronization rod 7 has been mounted in position can be pushed onto the rotatable part 5 whereby the remaining parts of the fixing device 8 can be substantially completely covered and it is possible for the synchronization rod 7 to fall out of the rotatable part 5.

FIG. 3a shows a diagrammatic plan view of the rotatable part 5 with the guide 9 provided therein for receiving and fixing the synchronization rod 7. The synchronization rod 7 is of a multi-part structure and includes a plug-in portion 7a which can be releasably connected to the remaining part of the synchronization rod 7. It is possible to see the locking device 12 which is in the locking condition in the illustrated embodiment. That locking condition is made possible by an arresting element 14 which in the position shown in FIG. 3a does not allow the synchronization rod 7 to be introduced into the guide 9 of the rotatable part 5. It is only when the handle element 10 is urged in the direction X by a user that it is possible for the synchronization rod 7 to be introduced into the guide 9 of the rotatable part 5. After the synchronization rod 7 has been pushed into the guide 9 and by manual release of the handle element 10 the arresting element 14 is automatically clamped within the guide 9 by spreading of the arresting element 14, as shown in FIG. 3b. FIG. 3c shows a perspective view of the synchronization rod 7 with the plug-in portion 7a which can be connected—preferably in force-locking relationship—to the rotatable part 5.

FIG. 4a shows a sectional view of the fixing device 8, wherein the plug-in portion 7a of the synchronization rod 7 has the arresting element 14 shown in FIG. 3a, which is constantly biased in the direction of the arresting position by a spring device 15. The arresting element 14 can be pushed against the force of the spring device 15 by the handle element 10 which is in the form of a slider, whereby the locking device 12 can be put into the release condition and the synchronization rod 7 can be introduced into the guide 9 of the rotatable part 5. The arresting element 14 is wedge-shaped and is mounted slidably along a corresponding inclined guide surface 16 of the plug-in portion 7a. The arresting element 14 is spread within the guide 9 of the rotatable part 5 by the inclined guide surface 16 and the force of the spring device 15, thereby producing a clamping connection to the rotatable part 5 as is shown in FIG. 4b. FIG. 4c shows an exploded view of the parts used. The rotatable part 5 has a guide 9, wherein the arresting element 14 which is biased by the spring device 15 produces a clamping connection between the plug-in portion 7a of the synchronization rod 7 and the rotatable part 5 of the respective actuating device 3a, 3b. The arresting element 14 can be moved into a release position again by actuation of the handle element 10 against the spring force so that dismantling is also possible without any problem.

FIGS. 5a through 5d show a further embodiment of a locking device 12 which in the locking condition prevents proper fitment of the synchronization rod 7 to the rotatable part 5 of the actuating device 3a and 3b. In the illustrated Figure the locking device 12 has a pivotably mounted lever 17 which at the same time also forms part of the fixing device 8 for fixing the synchronization rod 7 to the rotatable part 5. It is possible to see two arresting elements 14a and 14b which can each be spread in the direction Y by a pivotal movement of the lever 17, thereby forming a clamping connection between the synchronization rod 7 and the rotatable part 5. Reference 13 denotes a cover means mounted slidably relative to the synchronization rod 7. In a first mounting step therefore the two arresting elements 14a, 14b which are in the release position are introduced into the guide 9 of the rotatable part 5, as shown in FIG. 5b. As long as the lever 17 has not been actuated, the cover means 13 cannot be properly positioned over the remaining part of the fixing device 8 by the projecting lever 17. The two arresting elements 14a and 14b are spread within the guide 9 of the rotatable part 5 by tilting of the lever 17, whereupon the lever 17 assumes a position as shown in FIG. 5c. The lever 17 in FIG. 5c now bears against an outside surface of the synchronization rod 7. It is only in that pivotal position of the lever 17 that the cover means 13 can be properly positioned over the remaining part of the fixing device 8, as shown in FIG. 5d.

Even if the invention has been described in detail by reference to the illustrated embodiments, the invention is not limited to those embodiments. Rather a basic idea of the invention is to provide a locking device which prevents connection of the synchronization rod 7 in the locking condition so that incorrect assembly is excluded from the outset. It is only after the locking device has been intentionally moved into a release condition that correct assembly can be performed or properly concluded.

It will be appreciated that it is also possible for the synchronization rod 7 to be variable in length—in particular adjustable in length. It should also be noted that the proposed synchronization device 6 can also be used for stabilizing the running characteristics of a drawer which is displaceable in a furniture carcass 2, in which case the drawer has at opposite sides at least one respective gear performing the function of the rotatable part 5, which mesh with a corresponding rack. The desired synchronous movement of the two gears can be implemented in the mounted condition by way of the proposed synchronization device 6.

1. A synchronization device for synchronous movement of a first actuating device with at least one second actuating device, wherein the first and second actuating devices in the mounted condition are provided on an article of furniture for moving a movable furniture part, including:
a synchronization rod for transmitting a synchronous movement of the at least two actuating devices, and
at least one fixing device by way of which the synchronization rod can be releasably connected to at least one of the two actuating devices,
at least one releasable locking device which prevents the synchronization rod from being connected to the at least one fixing device in the locking condition of the locking device, wherein the locking device is in the locking condition without prior actuation by a user,
wherein the fixing device has a handle element to be actuated by a person and at least one arresting element which is releasable and arrestable by the handle element so that the synchronization rod can be secured after positioning has been effected relative to at least one of the two actuating devices.

2. The synchronization device according to claim 1, wherein parts of the locking device also form parts of the fixing device, by which the synchronization rod can be secured relative to at least one the two actuating devices.

3. The synchronization device according to claim 1, wherein the arresting element is substantially wedge-shaped and is mounted movably relative to the synchronization rod.

4. The synchronization device according to claim 1, wherein the arresting element is mounted slidably in a longitudinal direction of the synchronization rod.

5. The synchronization device according to claim 1, wherein the arresting element can be loaded by a spring device in the direction of the arresting position or is continuously loaded by the spring device in the direction of the arresting position.

6. The synchronization device according to claim 5, wherein the at least one arresting element and the spring device are part of the locking device.

7. The synchronization device according to claim 1, wherein the handle element is in the form of a slider, by which the arresting element is movable at least into the release position.

8. The synchronization device according to claim 1, wherein the handle element is in the form of a pivotably mounted lever, by which at least one arresting element can be clampingly fixed to or in one of the two actuating devices.

9. The synchronization device according to claim 8, wherein the pivotably mounted lever is part of the locking device.

10. The synchronization device according to claim 1, wherein there are provided at least two arresting elements which are movable into a clamping position by actuation of the handle element so that in that way the synchronization rod can be fixed relative to one of the two actuating devices.

11. The synchronization device according to claim 1, wherein in the mounted condition the synchronization rod is arranged on a rotatable part of an actuating device.

12. The synchronization device according to claim 11, wherein the fixing device is so adapted that the synchronization rod can be connected to the rotatable part of an actuating device even when the rotatable part is already pre-assembled to a side wall of a furniture carcass.

13. The synchronization device according to claim 1, wherein the synchronization rod can be introduced within a, preferably U-shaped, guide of an actuating device and can be braced therein.

14. The synchronization device according to claim 1, wherein the fixing device has a cover means, wherein the cover means can be positioned over the fixing device only when the synchronization rod is appropriately connected to at least one of the two actuating drives.

15. The synchronization device according to claim 14, wherein the cover means is mounted displaceably relative to the synchronization rod.

16. An article of furniture having at least one synchronization device according to claim 1.

17. The article of furniture according to claim 16, wherein the two actuating devices are mounted to opposite side walls of a furniture carcass, wherein a movement of the two actuating devices can be synchronized by way of the synchronization rod.
